(19) United States
(12) Patent Application Publication
(10) Pub. No.: US 2022/0198491 A1
(43) Pub. Date: Jun. 23, 2022

(54) Deep Learning Model on Customer Lifetime Value (CLV) for Customer Classifications and Multi-Entity Matching

(71) Applicant: Lucas GC Limited, Hong Kong (HK)

(72) Inventors: Wang-Chan Wong, Irvine, CA (US); Howard Lee, Porter Ranch, CA (US)

(21) Appl. No.: 17/133,497

(22) Filed: Dec. 23, 2020

(51) Int. Cl. G06Q 30/02; G06N 3/04; G06N 3/08; G06Q 30/00; G06Q 40/02; G06Q 40/08

(52) U.S. Cl. CPC G06Q 30/0204; G06N 3/0454; G06N 3/0445; G06N 3/08; G06Q 10/06375; G06Q 40/02; G06Q 30/0276; G06Q 40/08; G06Q 30/016

(57) ABSTRACT

Customer lifetime value (CLV)-base deep learning ensemble model for customer classification and multi-entity matching strategies is provided. In one novel aspect, the customer lifetime value (CLV)-base deep learning model (DNN) uses data mining and an ensemble of the recurrent neural network (RNN)-convolutional neural network (CNN) to identify potential prospects from lead generation, predicts churn/retention, predicts the next purchase, recommend strategies to keep and enhance existing customer relationships, and offer n-ary matching among prospects/customers, agents, products, and delivery strategies. In one embodiment, the CLV system obtains a CLV profile of a customer, generates, a CLV-based output for the customer using a DNN model, selects a n-ary matching for the customer based on the CLV-based output, and collects a feedback for the n-ary matching to update the n-nary matching until one or more exit conditions are met.

### TECHNICAL FIELD

The present invention relates generally to deep learning model and, more particularly, a deep learning model on customer lifetime value (CLV) for customer classifications and multi-entity matching strategies.

### BACKGROUND

The insurance industry is always an early adopter of information technologies. In recent years, the industry has embraced artificial intelligence (AI) to improve its operational efficiency and to lower costs. The industry moves with full front attacks in all aspects, from online direct to consumer, direct call center to support both online and telemarketing, and from person-to-person sales. There is a misconception that millennials are all in for the online and digital process. It has been shown that millennials want digital first, but not digital alone. That makes it more critical to cultivate these future customers by combining great online digital user experience and by supplementing it with person-to-person counseling and persuasion. Many people consider insurance is unnecessary unless it is required by law, such as healthcare and auto insurance. They are unwilling to admit that what they are being offered is a necessity, for instance, life insurance products. Often people are apprehensive when planning and looking into the future such as retirement. They are uncomfortable planning for the inevitable. One way to generate leads is to corner an underserved niche market such as the small commercial sub-segment. Further, insurance products are complicated. Most people lack financial wellness knowledge, which also builds the distrust of the insurance industry. Educating and counseling are needed to broaden people's knowledge of their own financial wellness to promote insurance products. The popularity of recent trends in disruptive fintech companies such as Betterment and Robinhood shows that people need alternatives to understand and experiment with their own financial wellness. Over the years, the insurance industry, through its agents, has developed various marketing strategies to acquire and keep customers. However, these marketing strategies are either highly personally relying on the skillful agent or are too complicated and unpredictable for the existing rule-based technology system to be effective.

Improvements and enhancements are required to develop a computer system to perform customer classifications and multi-entity matching strategies for the insurance industry.

### SUMMARY

Methods and systems are provided for the deep learning ensemble model for customer classification and multi-entity matching strategies. In one novel aspect, the customer lifetime value (CLV)-based deep learning model (DNN) uses data mining and an ensemble of the recurrent neural network (RNN)-convolutional neural network (CNN) to identify potential prospects from lead generation, predicts churn/retention, predicts the next purchase, recommend strategies to keep and enhance existing customer relationships, and offer n-ary matching among prospects/customers, agents, products, and delivery strategies. In one embodiment, the CLV system obtains a CLV profile of a customer including a set of personal information, a set of personal wealth profile, and a set of time-series-like of transactions, generates, output for the customer using a DNN model based on the CLV profile of the customer, wherein the DNN model is an ensemble of a recurrent neural network (RNN) model and a convolutional neural network (CNN) model, selects a n-ary matching for the customer based on the CLV-based output, and collects a feedback for the n-ary matching to update the n-nary matching until one or more exit conditions are met. In one embodiment, the CLV-based output is one or more comprising a CLV-based customer cluster, a product cluster and product ontologies, an agent cluster, attempts, a next purchase prediction, a next churn prediction, and a retention prediction. In another embodiment, the CLV-based output includes a customer classifier comprising top-level categories of profitable, non-profitable, and potential levels, and wherein each customer is mapped to a customer classifier with a matching CLV strategy. In one embodiment, the customer is a prospective customer without a record in the CLV system, and wherein the customer is classified with at least two classifiers comprising a potential classifier and a value classifier. In another embodiment, the selecting of n-ary match generates one or more matching agents, one or more matching products, and one or more modalities when the customer classifier indicates high potential. In yet another embodiment, the selecting of n-ary match generates a persuasion campaign when the customer classifier indicates low potential and high value. In one embodiment, the customer has a customer record in the CLV system, and wherein the customer is classified with at least two classifiers comprising a churn classifier and a repeat classifier. In another embodiment, the selecting of n-ary match generates one or more matching agents, one or more matching products, and one or more modalities when the customer classifier with a customized campaign based on customer classifier. In yet another embodiment, the customized campaign is intensive persuasion when the churn classifier indicates positive. In one embodiment, the customized campaign is cross-selling when the churn classifier indicates negative and the repeat classifier indicates positive. In another embodiment, the customized campaign is up selling when the churn classifier indicates negative and the repeat classifier indicates negative.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates exemplary diagrams for a customer lifetime value (CLV) system for customer classifications and multi-entity strategies in accordance with embodiments of the current invention.

FIG. 2 illustrates an exemplary decision tree to strategize insurance sales using a DNN model in accordance with embodiments of the current invention.

FIG. 3 illustrates an exemplary diagram for the CLV deep learning with RNN-CNN ensemble in accordance with embodiments of the current invention.

FIG. 4 illustrates exemplary diagrams of inputs for the CLV-based DNN model in accordance with embodiments of the current invention.

FIG. 5 illustrates exemplary diagrams of outputs for the CLV-based DNN model in accordance with embodiments of the current invention.

FIG. 6 illustrates an exemplary flow diagram for a CLV-based customer classification with n-ary matching for a prosect customer in accordance with embodiments of the current invention.

FIG. 7 illustrates an exemplary flow diagram for a CLV-based customer classification with n-ary matching for an existing customer in accordance with embodiments of the current invention.

FIG. 8 illustrates an exemplary flow chart for the CLV-based customer classification with multi-entity matching strategies in accordance with embodiments of the current invention.

### DETAILED DESCRIPTION

Reference will now be made in detail to some embodiments of the invention, examples of which are illustrated in the accompanying drawings.

A successful insurance company should offer a holistic solution that focuses on the entire financial wellness of a customer in an ecosystem with multiple participants, even with third party participants, to provide a customer with the best user experience so that the customer feels comfortable that he has a support team for his financial wellness. The ecosystem could include insurers, agents, advisors and coaches (to educate customer to think and understand his financial wellness), and other professionals such as attorneys (legal advices, living trust, wills, etc.), financial planners, accountants, banks, mortgage lenders and so on. The company should also implement agile process for both the frontend customers and the backend operations, especially in the claim management. Companies that can connect the backend systems that power quoting, claims, and underwriting with agency management systems and comparative raters to create a seamless experience optimized for both agent and policyholder will be able to give traditional customers what they need (a knowledgeable agent able to service their needs) and digital natives what they desire (personalized, contextualized interactions on the channel of their choices).

Insurance products are not intuitive to customers. People face a wide range of short-term and long-term financial challenges. The insurance companies are overly eager to sell the off-of-the-shelf insurance products. Customers also tend to forget that while getting insurance may involve time-consuming processes such as enrollment or document acquisition, the payoff is worth their trouble. To win customers who seek financial wellness, companies need to deviate from the traditional practice of simply focusing on product capabilities. The company must understand what customer wants and needs, and suggests a solution centered on managing their financial wellness, as opposed to presenting them with a basket of off-the-shelf products. It is not enough to just sell insurance products. Educating customers to manage and better their financial wellness is essential for successful insurance product marketing.

A multi-channel accessible digital platform is needed. The platform takes the customer's personal circumstances and evolving lifetime needs and offers personalized financial advice and information. The platform also offers access to third party participants such as advisor or counselor who provides tailored guidance and actionable solutions to various financial wellness concerns. It further provides answers to specific questions on finance-related topics, such as insurance benefits or legal services, and offers a wider range of customizable financial products that give customers the flexibility to bundle together various solutions to arrive at one product that meets all their needs.

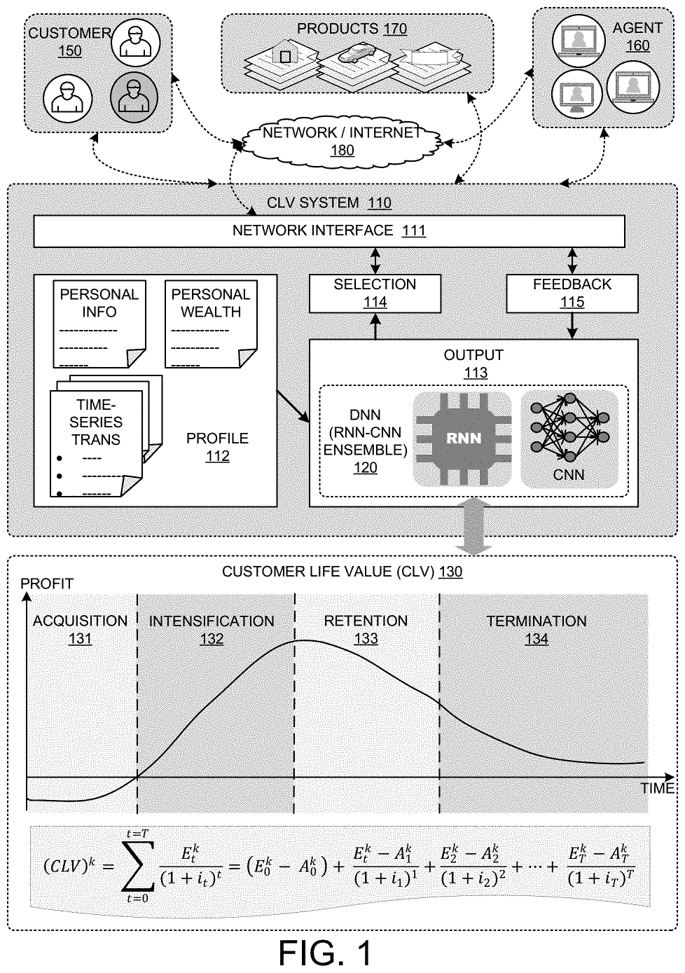

FIG. 1 illustrates exemplary diagrams for a customer lifetime value (CLV) system for customer classifications and multi-entity strategies in accordance with embodiments of the current invention. The basic strategies for insurance companies are to acquire more potential customers, to retain more customers and for longer period while capitalizing a customer's profitability by up-selling and/or cross-selling other products and services. In so doing, companies develop algorithms and practices to identify customers (e.g. customer segmentation), to create a marketing campaign to attract customer (e.g. direct marketing, social marketing), to retain more customers and for a longer period of time (e.g. loyalty program, reward system), and to predict the next purchase behavior of the customer based on the current state and behavior of the given customer. Customer lifetime value (CLV) is a tool that can help integrate all these four pieces.

An exemplary CLV graph and the CLV financial model 130 illustrates the CLV-based customer classification. CLV is considered to be an effective approach for marketing since it captures and ranks the profitability of a customer so that they can focus on marketing strategies and budgets to optimize their returns. CLV models a time-series like model of a value/profitability of a customer over a period of time. At the beginning of contacting the customer, the acquisition period 131 starts. The cost of customer acquisition is higher than the profit from the customer. After the acquisition period, in the intensification period 132, the company intensifies persuasive campaigns anchoring a customer's purchase decision; hence profit generated from the customer rises over time. Afterward, the CLV enters retention period 133 when the overall profit from the customer starts to decline. Company strategy shifts to allocate resources to retain the customer as long as possible. At the termination period 134, the profit from the customer continues to decrease over time and eventually stops completely. The CLV graph helps the insurance company to use different strategies during different phases of the customer. As the customer profile and/or situation changes, different strategies.

One advantage of using CLV is its simplicity in valuing a customer and determining selling strategies. For example, consider the formula below. It computes the present value and the future values of any potential revenues from a customer.

$${( CLV )}^{k} = {\sum }_{t = 0}^{t = T} \frac{{E}_{t}^{k}}{{( 1 - {i}_{t} )}^{t}} = ( {E}_{0}^{k} - {A}_{0}^{k} ) + \frac{{E}_{t}^{k} - {A}_{1}^{k}}{{( 1 - {i}_{1} )}^{1}} + \frac{{E}_{2}^{k} - {A}_{2}^{k}}{{( 1 + {i}_{2} )}^{2}} + … + \frac{{E}_{T}^{k} - {A}_{T}^{k}}{{( 1 + {i}_{T} )}^{T}}$$

(CLV)^{k}=Customer Lifetime Value of a customer k

Eₜ^{k}=revenue from a customer k at time t

A_{T}^{k}=expenses for a customer k at time t

K=customer k

t=time periods {t=0, 1, 2, . . . ,}

(t=0)=today

T=predicted duration of a customer's relationship

i=interest rate

The formula can be abstracted to a basic formula for calculating CLV for customer i at time t for a period T as in eq. (1) below:

$$C L {V}_{i , t} = {\sum }_{τ = 0}^{T} \frac{{Profit}_{i , t + τ}}{{( 1 + d )}^{τ}} \qquad ( 1 )$$

Where d is the discount rate.

Given a company offers multiple products/services, Profit_{i, t} can be defined as in eq. 2:

$${Profit}_{i , t} = {\sum }_{j = 1}^{J} {Product}_{ij , t} \times {Amount}_{ij , t} \times {Margin}_{j , t} \qquad ( 2 )$$

Where J is the number of different products sold, Product_{ij,t} is a binary variable indicating whether customer i purchases product j at time t, Amount_{ij,t} is the amount (revenue) of that product purchased, and Margin_{j,t} is the average profit margin for product j.

Equation (1) focuses on the total profitability of a customer in a fixed time period. It is called “relationship-level” model. Aggregating the relationship-level for all customers will help defining the company valuation. Equation (2) is called the service-level model. It disaggregates a customer's profitability into the contribution per product or service per period. It is useful in predicting purchase behavior.

Many mathematical models have been proposed to model CLV, especially its use in predicting the purchase behavior. The models proposed include simple regression, real options analysis, Recency-Frequency-Monetary (RFM) modeling, probabilistic models such as Pareto/NBD model and Markov chain model, econometric model on acquisition, retention, upselling, cross-selling and margin, and diffusion/grow model. There are so many models being proposed because there are many variations of parameter in computing the CLV and, unfortunately, many parameters are not readily available in the data record of a customer. When the parameter is not available, some of these models are used to forecast them. While the CLV concept is insightful, it is difficult to make any practical use of it by using these mathematical models, especially when there are potentially “hidden” variables, i.e. latent variables that are not directly observed but are rather inferred. Furthermore, many of these models require data of holistic customer history, including revenues and costs such as acquisition cost, direct cost, and activity-based costs, in order to compute the profit margin. Collecting these data is difficult, if not impossible.

In one novel aspect, a deep learning ensemble approach, which includes the data mining, machine learning, and the recurrent neural network—convolutional neural network (RNN-CNN), is provided to model the service-level CLV with a mixture of behavior and non-behavior. A CLV system 110 includes a network interface 111, a profile module 112, an output module 113, a selection module 114, and a feedback module 115. CLV system 110 interacts with the customer 150, the agent 160, products 170 and the network/Internet 180. In one embodiment, one or more network interfaces 111 connect the system with a network. A profile module 112 obtains a customer lifetime value (CLV) profile of a customer, including a set of personal information, a set of personal wealth profile, and a set of time-series like of transactions. An output module 113 generates a CLV-based output for the customer using a DNN model based on the CLV profile of the customer, wherein the DNN model is an ensemble of a recurrent neural network (RNN) model and a convolutional neural network (CNN) model. A selection module 114 selects a n-ary matching for the customer based on the CLV-based output. A feedback module 115 collects feedback for the n-ary matching to update the n-nary matching until one or more exit conditions are met. In one embodiment, output module 113 uses DNN model to analyze the inputs of the customer profile and selects a n-ary matching for the customer. The DNN model is an ensemble of CNN and RNN and/or data mining methods. The output module, without using the formula-based CLV financial model as in 130, generates CLV-based customer classification and n-nary matching strategies using the DNN model. The deep learning model of output module 113 identifies potential prospects from lead generation, predicts churn/retention, predicts the next purchase, recommends strategies to keep and enhance existing customer relationships, and offers n-ary matching among prospects/customers, agents, products, and delivery strategies.

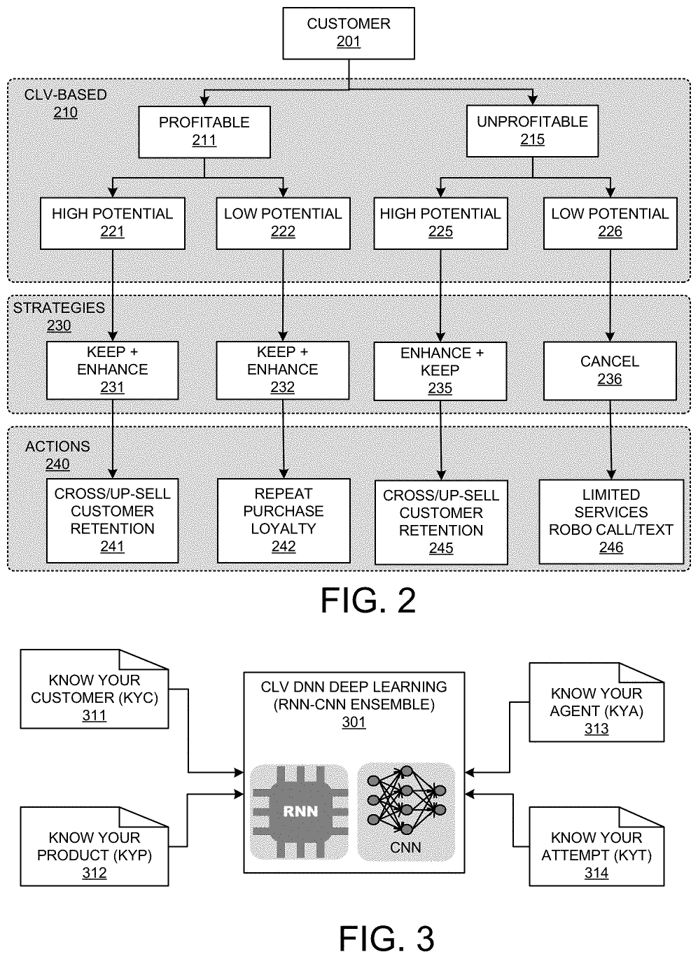

FIG. 2 illustrates an exemplary decision tree to strategize insurance sales using a DNN model in accordance with embodiments of the current invention. In one embodiment, the CLV is based on a period of time where large set of customer data records can be obtained, for example, 3 to 5 years. One of the tasks of the deep learning ensemble is to classify customers based on these customer data records. Based on the CLV theory, there are many practical customer classifications, such as the model by Monika Severie, SAS Insititue Germany Fachhochschule Nuertingen (“the Severie Model”). FIG. 2 shows the outline classification of the Severie Model. Instead of the traditional rule-based procedures, the CLV system's RNN-CNN ensemble classifies the customer and generate corresponding n-ary strategies based on customer profile and trained DNN model. The CLV-based customer classification uses the DNN model to set a classifier to the customer/prospect that indicates the CLV period of the customer, the acquisition, the intensification, the retention, or the termination. The CLV system models a three-step strategy for a customer 201 including a CLV-based customer classification 210, a matching strategies procedure 230, and an actions procedure 240. In the first phase, the CLV system generates a customer classifier for customer 201. In one embodiment, the CLV-based customer classifier is a multi-level classifier. In one embodiment, the first category includes the profitable 211 category, and the unprofitable 212. The second level includes a high potential category and a low potential category. Based on this model, customer 221 is classified in one of the CLV-based classifications including the profitable and high potential 221, the profitable and low potential 222, the nprofitable and high potential 225, and the unprofitable and low potential 226. In one embodiment, the CNN-RNN ensemble model not only classifies the customer in CLV model, but also generates the n-ary matching strategy and action based on the customer classification and the product, the agent information. A keep and enhance strategy 231 and a cross-selling and/or up-selling with customer retention action 241 are determined for customer with classification 231. A keep and enhance strategy 232 and a repeat purchase loyal action 242 are determined for customer with classification 232. An enhance and keep strategy 235 and a cross-selling and/or up-selling with retention action 245 are determined for customer with classification 225. A cancel strategy 236 with limited services, such as robotic call/text/email action 246 are determined for customers with classification 236.

FIG. 3 illustrates an exemplary diagram for the CLV deep learning with RNN-CNN ensemble in accordance with embodiments of the current invention. CLV deep learning with RNN-CNN ensemble 301 identifies a set of customers in know your customer (KYC) 311, a set of corresponding products for each customer in know your product (KYP) 312, a set of agents for each corresponding customer in know your agent (KYA) 313, and a set of strategies/attempts in know your attempts (KYT) 314. The CLV DNN deep learning is an RNN-CNN ensemble. In the ensemble, the RNN is used to learn and model the time-series like behavior of the customer. The trained RNN will help to predict the behaviors, including the likelihood of churn, the next purchase information, the retention prediction, etc. The RNN-CNN ensemble model is used to model the n-ary relationships with time-series behaviors.

CLV-based DNN model 301 generates a set of domain-specific databases, including Know Your Customer (KYC) 311, Know Your Product (KYP) 312, Know Your Agent (KYA) 313, and Know Your Attempt (KYT) 314. Attempt refers to the delivery of the persuasion such as time, style, and where. Big Data for each specific domain is obtained to develop and train CLV-based DNN 301 on customer, product, agent, and attempt. In one embodiment, given a potential target, CLV-based DNN 301 identifies a reference attempt modality, one or more objects, and one or more matching agents to maximize the success of marketing the insurance product. Other types of queries are supported by CLV-based DNN 301. In another embodiment, given one or more insurance products, CLV-based DNN 301 identifies a group of potential customers, a reference attempt modality, and one or more matching agents to maximize success. In one embodiment, the identified customer, product, agent, and attempt are ranked. CLV-based DNN 301 generates the n-ary match for a customer based on the CLV-based customer classification. In one embodiment, the results of one or more attempts with the customer are feedback to CLV-based DNN 301. New strategies/attempts, agents, and/or products are generated based on the feedback.

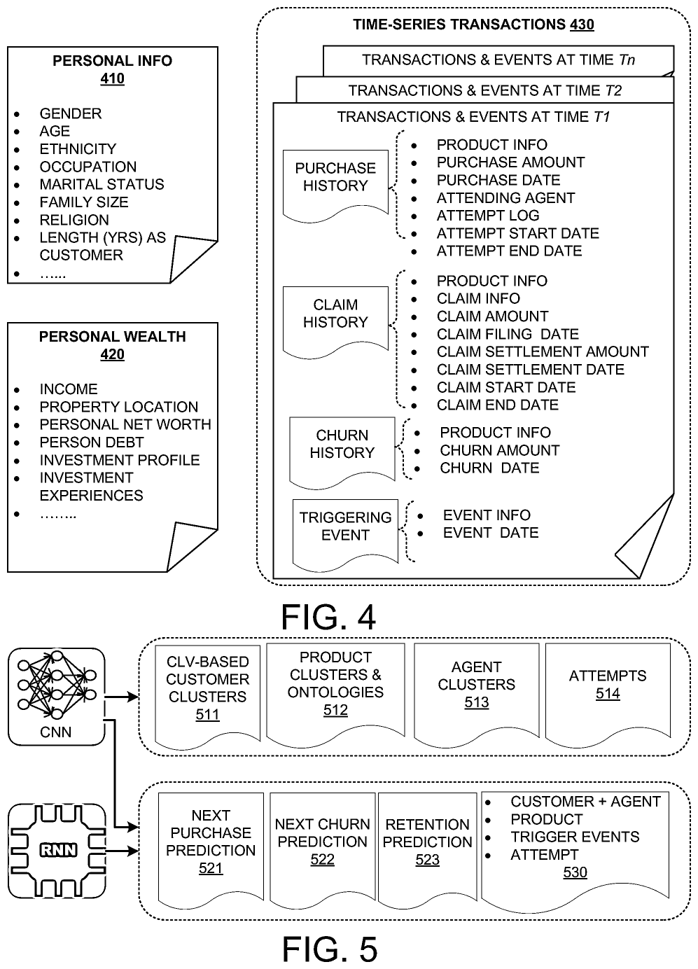

FIG. 4 illustrates exemplary diagrams of inputs for the CLV-based DNN model in accordance with embodiments of the current invention. In one embodiment, deep learning model with RNN-CNN ensemble are used to classify the customer and generate a corresponding n-ary match for the agent, the product, and/or strategy/attempt. The RNN-CNN ensemble is trained by time-series behavior to predict the customer behavior and, thereby, generates the n-ary match. In one embodiment, the input of the CLV-based DNN model includes personal information 410, personal wealth information 420, and a set of time-series like transactions 430, including transactions and events at time T1, T2, . . . Tn. In one embodiment, personal information 410 includes one or more elements comprising the gender, age, ethnicity, occupation, marital status, family size, religion, length (years) being a customer. The personal wealth information 420 includes one or more elements comprising the income, the property (residence) location, the personal net worth, the personal debt, the investment profile, the investment experience. The transactions and events at time t1 include one or more records of the purchase history, the claim history, the churn history, and the triggering events. The purchase history includes one or more entries comprising the product information, the purchase amount, the purchase date, the attending agent, the attempt log (time, style and where), the attempt start date, and the attempt end date. The claim history includes one or more entries comprising the product information, the claim information, the claim amount, the claim filing date, the claim settlement amount, the claim settlement date, the claim start date, and the claim end date. The churn history includes one or more entries comprising the product information, the churn amount, and the churn date. The triggering event includes one or more entries comprising the event information and the event date.

FIG. 5 illustrates exemplary diagrams of outputs for the CLV-based DNN model in accordance with embodiments of the current invention. In one embodiment, the RNN-CNN ensemble is used to output a set of n-ary matches for the customer. A set of outputs 511, 512, 513, and 514 are generated using the CNN model. A prediction set of outputs 521, 522, 523, and 530 are generated using both the CNN and the RNN. Output 511 are CLV-based customer clusters. Output 512 are product clusters and their ontologies. Output 513 are agent clusters. Output 514 are attempts. Output 521 predicts the next purchase. Output 522 is a next churn prediction. Output 523 is a retention prediction. Output 530 generates a set of n-ary matches, including the customer and the matching agent, the matching product, a set of triggering events, and one or more attempts/strategies.

On the top level of the customer classification is the existing customer and the customer prospects who are not yet customers. The procedure using the CLV-based system for customer classification with n-ary matchings are illustrated.

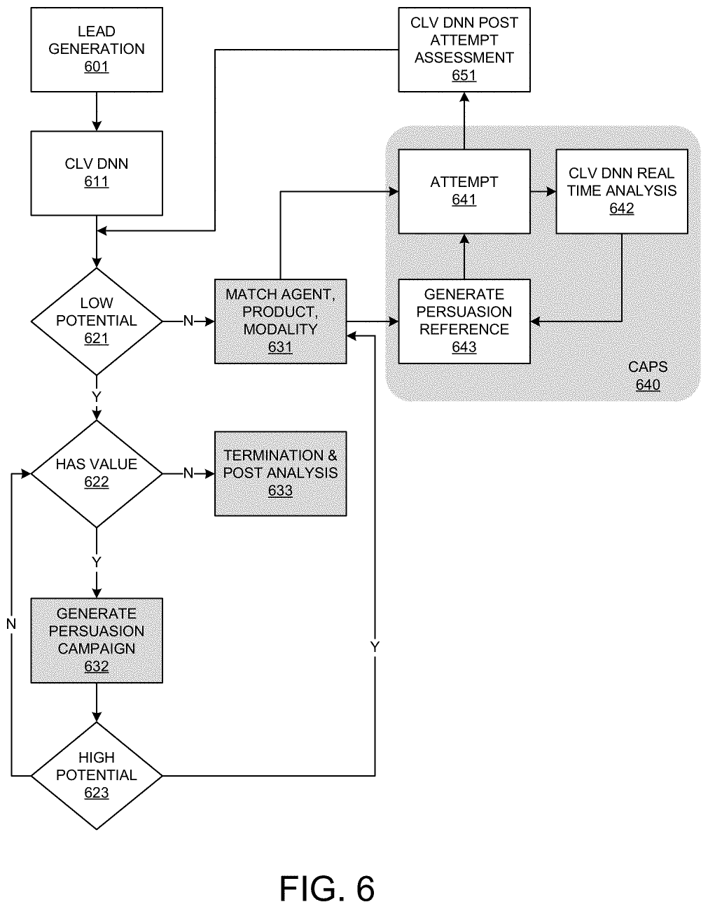

FIG. 6 illustrates an exemplary flow diagram for a CLV-based customer classification with n-ary matching for a prospect customer in accordance with embodiments of the current invention. At step 601, the CLV system obtains prospect customer's profile, including personal information and/or personal wealth information and generates a customer lead. At step 611, the CLV system performs CLV-based DNN to get the CLV-based customer classification of the customer. At step 621, the CLV system determines whether the customer is of low potential of being a customer based on the customer classifier generated by the CLV-based DNN. If step 621 determines yes, the CLV system moves to step 631 and generates the n-ary match for the customer, including the attempts, the one or more products, and/or the modality. If step 621 determines no, the CLV system, at step 622, determines if the customer has value based on the customer classifier generated by the CLV DNN. If step 622 determines no, the CLV system moves to step 633 for the termination process and post-termination analysis. If step 622 determines yes, the CLV system moves to step 632 to generate a persuasion campaign for the customer. Subsequently, at step 623, the CLV system determines, after the persuasive campaign, whether the customer is classified as high potential. If step 623 determines no, the CLV system moves to step 622 to determine whether the customer has value and reiterates the process. If step 623 determines yes, the CLV system moves to step 631 and generates the n-ary match for the customer, including the attempts, the one or more products, and/or the modality. Once the n-ary match is generated at step 631, the CLV system uses a computer-aided persuasive system (CAPS) 640 to carry the generated strategies. At step 643, CAPS 640 generates persuasive references based on the n-ary match. The persuasive reference is updated in real-time using a CLV DNN real-time analysis procedure 642. The generated persuasive reference is used by attempt 641. In one embodiment, attempt 641 interacts with the customer using the generated persuasive materials as references and generates real-time feedback information to CLV DNN 642. The persuasive reference is updated accordingly in real-time to best aid the persuasive procedure. Once the attempt 641 is concluded, the feedback and/or the whole process is sent to CLV DNN post attempt assessment 651 for analysis. The CLV system moves to step 621 to determine whether the customer is high potential or low potential and start the iteration based on the post attempt assessment.

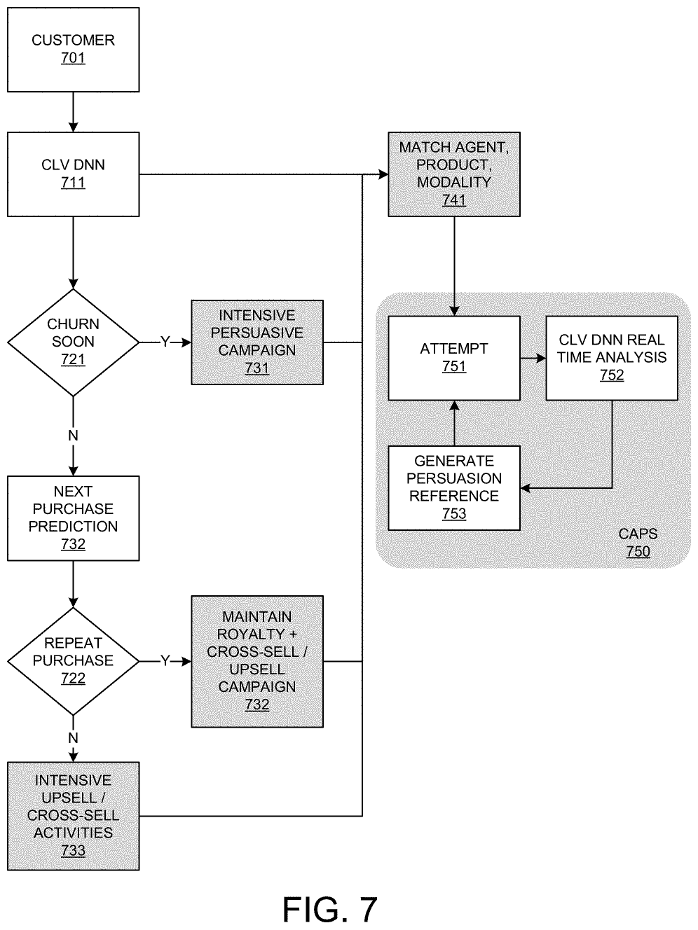

FIG. 7 illustrates an exemplary flow diagram for a CLV-based customer classification with n-ary matching for an existing customer in accordance with embodiments of the current invention. At step 701, the CLV system obtains customer's profile, including personal information, personal wealth information, and/or time-series transaction histories. At step 711, the CLV system performs CLV-based DNN to get the CLV-based customer classification of the customer. At step 721, the CLV system determines whether the customer classifier indicates the customer to be churning soon. If step 721 determines yes, the CLV system moves to step 731 and starts an intensive persuasive campaign. If step 721 determines no, the CLV system, at step 732 performs the next purchase prediction. At step 722, the CLV system determines if the customer is likely to have a repeat purchase. If step 722 determines no, the CLV system moves to step 733 for intensive upselling/cross-selling activities based on output from the CLV DNN procedure. If step 722 determines yes, the CLV system moves to step 732 to perform maintaining loyalty and/or cross-selling/up-selling campaign. Once the persuasive campaign are determined based on the customer classifications at steps 731, 732, and 733, the CLV system moves to step 741 and generates the n-ary match for the customer, including the attempts, the one or more products, and/or the modality. Once the n-ary match is generated at step 741, the CLV system uses a computer-aided persuasive system (CAPS) 750 to carry the generated strategies. At step 753, CAPS 750 generates persuasive references based on the n-ary match. The persuasive reference is updated in real-time using a CLV DNN real-time analysis procedure 752. The generated persuasive reference is used by attempt 751. In one embodiment, attempt 751 interacts with the customer using the generated persuasive materials as references and generates real-time feedback information to CLV DNN 752. The persuasive reference is updated accordingly in real-time to best aid the persuasive procedure.

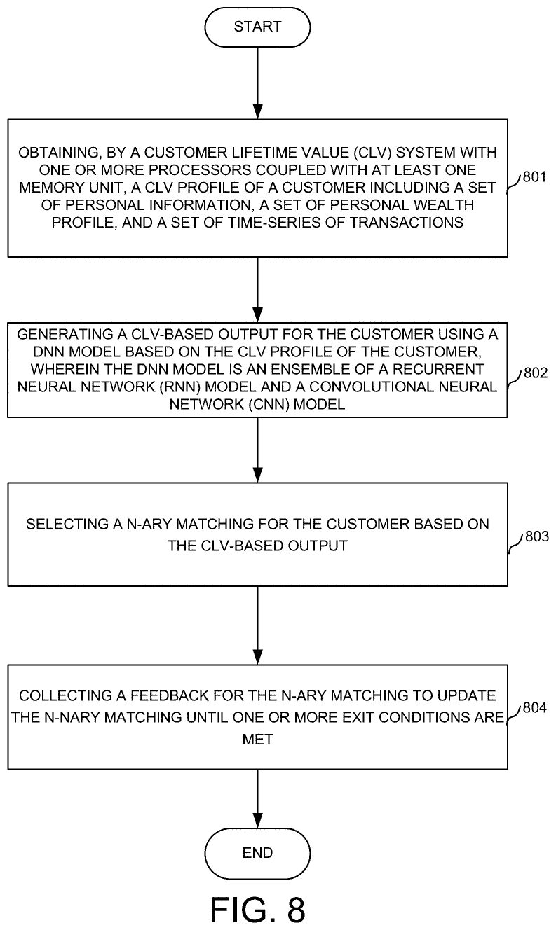

FIG. 8 illustrates an exemplary flow chart for the CLV-based customer classification with multi-entity matching strategies in accordance with embodiments of the current invention. At step 801, the CLV system obtains a CLV profile of a customer including a set of personal information, a set of personal wealth profile, and a set of time-series of transactions. At step 802, the CLV system generates a CLV-based output for the customer using a DNN model based on the CLV profile of the customer, wherein the DNN model is an ensemble of a recurrent neural network (RNN) model and a convolutional neural network (CNN) model. At step 803, the CLV system selects a n-ary matching for the customer based on the CLV-based output. At step 804, the CLV system collects a feedback for the n-ary matching to update the n-nary matching until one or more exit conditions are met.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1. A method, comprising:
obtaining, by a customer lifetime value (CLV) system with one or more processors coupled with at least one memory unit, a CLV profile of a customer including a set of personal information, a set of personal wealth profile, and a set of time-series of transactions;
generating a CLV-based output for the customer using a deep learning (DNN) model based on the CLV profile of the customer, wherein the CLV-based output follows a predefined CLV model including a relationship-level model and a service-level model, and wherein the relationship-level model is CLV_{i,t}=Σ_{τ=0}^{T}Profit_{i,t+τ}/(1+a)^{τ} for customer i at time t for a period T with d being the discount rate, and the service-level model is Σⱼ₌₁^{J}Product_{ij,t}×Amount_{ij,t}×Margin_{ij,t}, for customer i of product j at time t for with the total number of product being J, and wherein the DNN model is an ensemble of a recurrent neural network (RNN) model and a convolutional neural network (CNN) model;
selecting a n-ary matching among multiple factors including the customer, products, modality, and one or more persuasion references for the customer based on the CLV-based output; and
collecting a feedback for the n-ary matching to update the n-nary matching until one or more exit conditions are met.

2. The method of claim 1, wherein the CLV-based output is one or more comprising a CLV-based customer cluster, a product cluster and relationship, an agent cluster, attempts, a next purchase prediction, a next churn prediction, and a retention prediction.

3. The method of claim 1, wherein the CLV-based output includes a customer classifier comprising top-level categories of profitable, non-profitable, and potential levels, and wherein each customer is mapped to a customer classifier with a matching CLV strategy.

4. The method of claim 3, wherein the customer is a prospective customer without a record in the CLV system, and wherein the customer is classified with at least two classifiers comprising a potential classifier and a value classifier.

5. The method of claim 4, wherein the selecting of n-ary match generates one or more matching agents, one or more matching products, and one or more modalities when the customer classifier indicates a potential value higher than a predefined potential threshold.

6. The method of claim 4, wherein the selecting of n-ary match generates a persuasion campaign when the customer classifier indicates a potential value lower than a predefined potential threshold and a profit value higher than a predefined profit threshold.

7. The method of claim 3, wherein the customer has a customer record in the CLV system, and wherein the customer is classified with at least two classifiers comprising a churn classifier and a repeat classifier.

8. The method of claim 7, wherein the selecting of n-ary match generates one or more matching agents, one or more matching products, and one or more modalities when the customer classifier with a customized campaign based on customer classifier.

9. The method of claim 8, wherein the customized campaign is intensive persuasion when the churn classifier indicates positive.

10. The method of claim 8, wherein the customized campaign is cross-selling when the churn classifier indicates negative and the repeat classifier indicates positive.

11. The method of claim 8, wherein the customized campaign is up-selling when the churn classifier indicates negative and the repeat classifier indicates negative.

12. A system, comprising:
one or more network interfaces that connects the system with a network;
a profile module that obtains a customer lifetime value (CLV) profile of a customer including a set of personal information, a set of personal wealth profile, and a set of time-series of transactions;
an output module that generates a CLV-based output for the customer using a deep learning (DNN) model based on the CLV profile of the customer, wherein the CLV-based output follows a predefined CLV model including a relationship-level model and a service-level model, and wherein the relationship-level model is CLV_{i,t}=Σ_{τ=0}^{T}Profit_{i,t+τ}/(1+a)^{τ} for customer i at time t for a period T with d being the discount rate, and the service-level model is Σⱼ₌₁^{J}Product_{ij,t}×Amount_{ij,t}×Margin_{ij,t}, for customer i of product j at time t for with the total number of product being J, and wherein the DNN model is an ensemble of a recurrent neural network (RNN) model and a convolutional neural network (CNN) model;
a selection module that selects a n-ary matching among multiple factors including the customer, products, modality, and one or more persuasion references for the customer based on the CLV-based output; and
a feedback module that collects a feedback for the n-ary matching to update the n-nary matching until one or more exit conditions are met.

13. The system of claim 12, wherein the CLV-based output is one or more comprising a CLV-based customer cluster, a product cluster and relationship, an agent cluster, attempts, a next purchase prediction, a next churn prediction, and a retention prediction.

14. The system of claim 12, wherein the CLV-based output includes a customer classifier comprising top-level categories of profitable, non-profitable, and potential levels, and wherein each customer is mapped to a customer classifier with a matching CLV strategy.

15. The system of claim 14, wherein the customer is a prospective customer without a record in the CLV system, and wherein the customer is classified with at least two classifiers comprising a potential classifier and a value classifier.

16. The system of claim 15, wherein the selecting of n-ary match generates one or more matching agents, one or more matching products, and one or more modalities when the customer classifier indicates high a potential value higher than a predefined potential threshold.

17. The system of claim 15, wherein the selecting of n-ary match generates a persuasion campaign when the customer classifier indicates a potential value lower than a predefined potential threshold and high a profit value higher than a predefined profit threshold.

18. The system of claim 14, wherein the customer has a customer record in the CLV system, and wherein the customer is classified with at least two classifiers comprising a churn classifier and a repeat classifier.

19. The system of claim 18, wherein the selecting of n-ary match generates one or more matching agents, one or more matching products, and one or more modalities when the customer classifier with a customized campaign based on customer classifier.

20. The system of claim 19, wherein the customized campaign is intensive persuasion when the churn classifier indicates positive, otherwise, when the churn classifier indicates negative and the repeat classifier indicates positive the customized campaign is cross-selling, otherwise, when the churn classifier indicates negative and the repeat classifier indicates negative, the customized campaign is up-selling.
